(19) United States
(12) Patent Application Publication
(10) Pub. No.: US 2004/0142124 A1
(43) Pub. Date: Jul. 22, 2004

(54) Trays

(76) Inventor: Miles Roylance Patterson, Hastings (NZ)

Correspondence Address: JACOBSON HOLMAN, 400 SEVENTH STREET, N.W., WASHINGTON, DC, 20004, US

(21) Appl. No.: 10/418,315

(22) Filed: Apr. 18, 2003

(30) Foreign Application Priority Data
Apr. 18, 2002 (NZ) 518485

(51) Int. Cl. F16L 1/00

(52) U.S. Cl. 428/34.1; 428/174

(57) ABSTRACT

A tray thermoformed from a sheet or web of a thermoplastics film characterised in that it has at least one product retention zone inward of a raised perimeter, said retention zone of the tray presenting at least one upstanding protuberance such as for example spikes.

### FIELD OF THE INVENTION

The present invention relates to trays. The invention also relates to methods of use of such trays and combinations of such trays with other items.

### BACKGROUND OF THE INVENTION

Frequently a product such as meats (red or white) and/or fish or any derivative of any such meats or fish (eg; pate, reconstituted slices, etc.) is presented in a tray under a transparent cover which can be a tear off sheet or a wrap. In some forms such a cover can be one of a series of covers to allow by serial removal blooming of the meat or other content of the tray.

The move from supermarket packing to centralised packing of fresh meat and as a consequence the distribution of fresh meat in case ready tray packs has created a need to secure the meat in the tray.

Currently centrally packed case ready meat is often displaced within the tray for two main reasons:

Firstly it is not held securely in the tray by the overwrap film or lid film as there is often a requirement for a head space gas between the overwrap film or lid film and the meat.

Also even when the overwrap film or lid film is in contact with the meat provision some degree of security against movement the journey through the distribution chain from packing to the retail case display is such that the meat is often displaced.

The object of the present invention is to novel trays as well as to novel combinations or assemblies which involves trays which addresses the above disadvantages or which will at least provide the public with a useful choice.

### BRIEF SUMMARY OF THE INVENTION

Accordingly, in a first aspect the present invention consists in a tray thermoformed from a sheet or web (hereafter “web”) of a thermoplastics film characterised in that it has at least one product retention zone (“the product retention zone”) inward of a raised perimeter, said retention zone of the tray presenting at least one upstanding (preferably spike-like) protuberance.

Preferably said at least one upstanding protuberance is a plurality of spikes.

Preferably at least one (or some) of the spikes is (are) at least about as upstanding as it is (they are) wide at its (their) base.

Preferably each said spike(s) stands (stand) proud of the surrounding thermoplastic material which itself is raised (eg; as a rib, ridge or plateau) from at least much of the remainder of the retention zone defining thermoplastic material.

Preferably the or each said upstanding protuberance is formed so as, when viewed from below the tray, to provide a blind recess.

Preferably each said blind recess underlies a solid plastics point.

Preferably said protuberances are substantially conical.

Preferably said tray is substantially rectangular or square in plan albeit with optional corner truncation or rounding.

Preferably the or each protuberance stands proud from a rib, ridge or plateau.

Preferably said raised perimeter defines upstanding (but preferably outwardly splayed) walls.

Preferably said walls include a peripheral flange.

Preferably said flange is flat or convex (eg; curving from a curved or flat flange region or lip to define a distal downturn).

Preferably the ribs, ridges and/or plateau are adapted

(i) to allow liquid pooling or accumulation (in the absence of a soaker pad) or exudate in use from any content place on said tray in said retention zone, and/or

(ii) to allow channelling of gas under the tray even when it is fully wrapped by a cling film.

Preferably said raised perimeter includes one or more opening through the plastics material.

Preferably said opening(s) is (are) in a set down region or set down regions of the raised perimeter (ie; of a peripheral flange thereof). They can act in a gas exchange procedure substantially as disclosed in PCT/US96/16117 of Transhumance.

In a further aspect the present invention consists in, in combination, a tray as aforesaid and a soaker pad capable of being positioned on the tray over at least part of said retention zone yet to still present a capability, owing to the presence of such upstanding protuberances, of locating a meat, fish or the like product or products therein.

In yet a further aspect the present invention consists in an assembly comprising or including

a tray of a thermoplastics material having at least one upstanding protuberance inwardly of the periphery thereof,

(optionally) a soaker pad or the equivalent located on the tray over said at least one upstanding protuberance,

at least one meat, fish or derivative products located on said tray (optionally at least in part over any optional soaker pad), and

a closure onto and/or at least in part about the tray over the meat, fish or derivative product(s) of a film or foil.

Preferably said tray has been thermoformed from a sheet or web (hereafter “web”) of a thermoplastics material.

Preferably said closure is with a plastics film.

Preferably said closure is as a wrap.

In another form, preferably said closure is as a tear off sheet welded (eg; heat, RF, acoustically or the like) or otherwise affixed (eg; adhesive) to an upper region of a raised periphery of the tray.

Preferably said soaker pad is interposed between the tray and the meat, fish or derivative product, and the upper surface of the soaker pad substantially conforms to and/or is penetrated by the protuberance(s).

Preferably said tray is a tray as previously defined in accordance with the present invention.

In some forms of the present invention a plurality of product covering sheets are provided.

Preferably the closure over the product(s) is of a transparent material.

In a further aspect the present invention consists in the use of a tray in accordance with the present invention.

In still a further aspect the present invention consists in a presentation of a meat, fish or derivative product(s) in a tray as aforesaid under an appropriate closure or in an assembly as previously defined.

In yet a further aspect the present invention consists in a method of packaging meat, fish or derivative product(s) which involves the operative use of a tray in accordance with the present invention or which results in an assembly in accordance with the present invention.

In a further aspect the present invention consists in a tray of any of the forms hereinafter described with reference to any one or more of the accompanying drawings.

In still a further aspect the present invention consists in a method of displaying meat, fish or derivative product(s) when performed substantially as herein described with reference to any one or more of the accompanying drawings.

In yet a further aspect the present invention consists in an assembly including a tray which includes sealed therein meat, fish or derivative products in a way substantially as herein described with reference to any one or more of the accompanying drawings.

As used herein the term “meat” includes red and white meats (eg; red meats such as beef, veal, mutton, lamb, venison, etc. and white meats such as pork and poultry in all conceivable forms). Likewise “fish” includes all fish species and other seafood, eg; crustaceans, shellfish, etc. and “derivative” in respect of such products can be forms of processed or blended “meat” and/or “fish” and may include other ingredients.

As used herein the term “soaker pad” can include a plurality of soaker pads or matrices. By “soaker pad” is included any matrix, fabricated or otherwise, and whether using woven, non woven, particulate, cellular, particulate, or other matrix which has a capability of absorbing or locating a liquid exudate.

Preferably said matrix can and preferably does underlie a liquid impermeable barrier, eg; of a plastics film or a foil.

For example, one type of soaker pad envisaged for use in an assembly of the present invention is an absorbent matrix within a polyethylene film envelope, the lower part of the envelope being perforated to allow access of the exudate into the absorbent matrix (eg; of paper or other non woven fibres). Another type of soaker pad the bottom side may simply be a fibrous (non woven) spun bond of a polyester or the like attached at least in part to overlying food grade plastics film (eg; polyethylene or polyester) impervious to liquid and enclosing an absorbent matrix within the envelope (eg; of Super Absorbent Powder (SAP), paper or both).

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

A preferred form of the present invention will now be described with reference to the accompanying drawings in which;

FIG. 1 is a plan view of one preferred embodiment of the present invention,

FIG. 2 is a cross section of a rib of the embodiment of FIG. 1 showing how, from the sheet or web of thermoplastic film, a conical upstanding protuberance from the rib has been defined with a more or less solid plastics point above what, when being viewed from below, is a blind recess,

FIG. 3A is a similar view to that of FIG. 2 but showing a soaker pad of any appropriate form substantially conforming to the protuberance and thus presenting still an upstand capable of engaging into any meat, etc. located thereon,

FIG. 3B is a variant of FIG. 3A where the meat, fish or derivative product simply adheres to the upper surface of the soaker pad, the soaker pad itself being located by the spikes,

FIG. 4 is a perspective view from above of a tray as depicted in FIG. 1,

FIG. 5 is a perspective view from below of the tray of FIG. 4,

FIG. 6 is a perspective view from above of the tray of FIG. 4 but showing a soaker pad positioned on the product retention zone (there preferably being a single product retention zone),

FIG. 7 in a similar view to that of FIG. 4 and shows a different embodiment having fewer ridges etc,

FIG. 8 shows a diagrammatic section of a tray formed in accordance with the present invention showing a simply lidding arrangement,

FIG. 9 is a similar view to that of FIG. 8 but where the closure is by over wrapping with a stretch film,

FIG. 10 is a similar view to that of FIGS. 8 and 9 but where the closure is affected by seam welding of two webs of shrink film to provide a tight encasement of the tray,

FIG. 11 is an enlarged view of a seam provided by a closure technique as in FIG. 10, and

FIG. 12 shows from below a tray (simply shown as a perimeter) encased by a flow wrap method which provides both longitudinal and end seals.

### DETAILED DESCRIPTION OF THE INVENTION

The trays of the present invention are preferably thermoformed (as injection moulding and blow moulding are more expensive operations) from a web of a thermoplastics material such as polystyrene, polyester, PVC, polypropylene, polyethylene or any combinations of these or combinations with other thermoplastic materials. The thermoforming can be under the effect of vacuum or pressure or can be under the effect of a combination of the both. This is in addition to any preferred reliance on gravity.

The choice of thickness and the positioning and size of the preferred protuberance is such that the melt flow index of the thermoplastic material chosen defines in the cavity to define each protuberance an adequate protuberance for direct or indirect product location purposes without any undue weakening of the tray bottom and without rendering perforate the tray bottom.

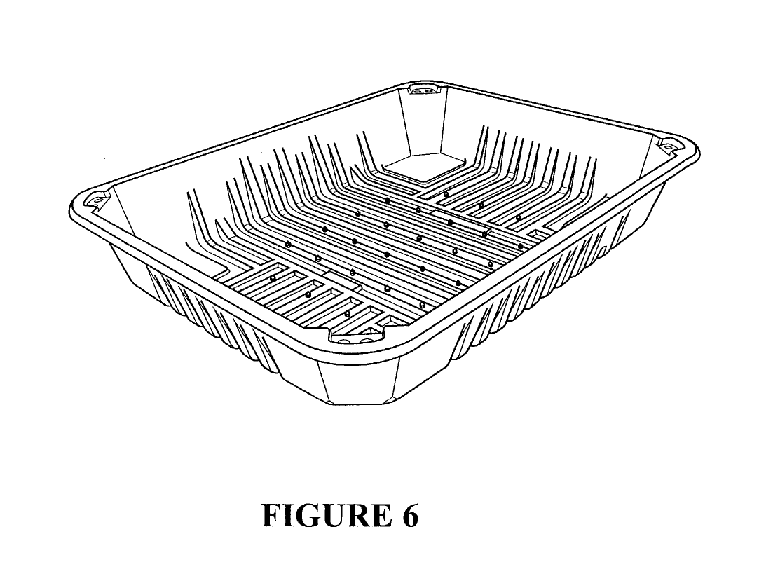

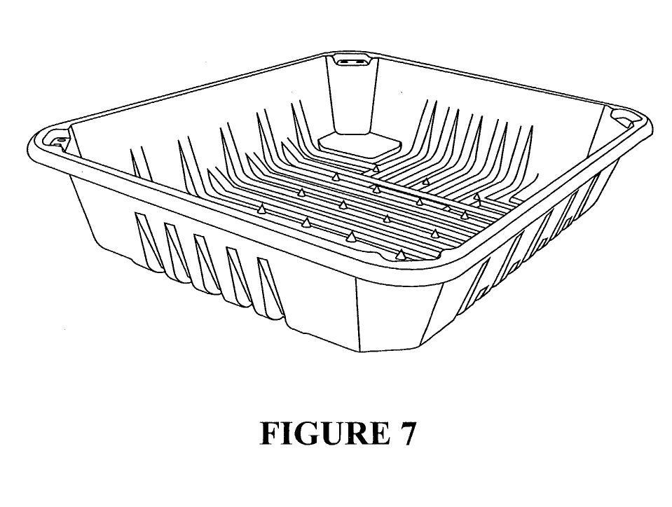

Trays in accordance with the present invention are preferably self nesting and are useful in packs where the product on the soaker pad shown in FIG. 6 is simply (at least initially) overlayed with a sheet of an appropriate film material (such as a clear polyethylene based lidding film preferably containing an anti-fog and preferably allowing rapid gas exchange through its structure) which is heat bonded in some way (eg; heat, RD, acoustic, etc.) to the peripheral lip. In other embodiments however there can be a wrap over the top of the perimeter and the product of the tray and around over the base with a film such as a clear polyethylene based or PVC based stretch film preferably containing an anti-fog and preferably allowing rapid gas exchange through its structure. An example being our MAPA™ film. Or a clear polyethylene based or PVC based shrink film, preferably containing an anti-fog and preferably allowing rapid gas exchange through its structure, an example being Dupont's CR5 film.

In some preferred forms of the present invention where a bloom characteristic for meat is desired a sealed environment may be generated inside the containment region of the tray.

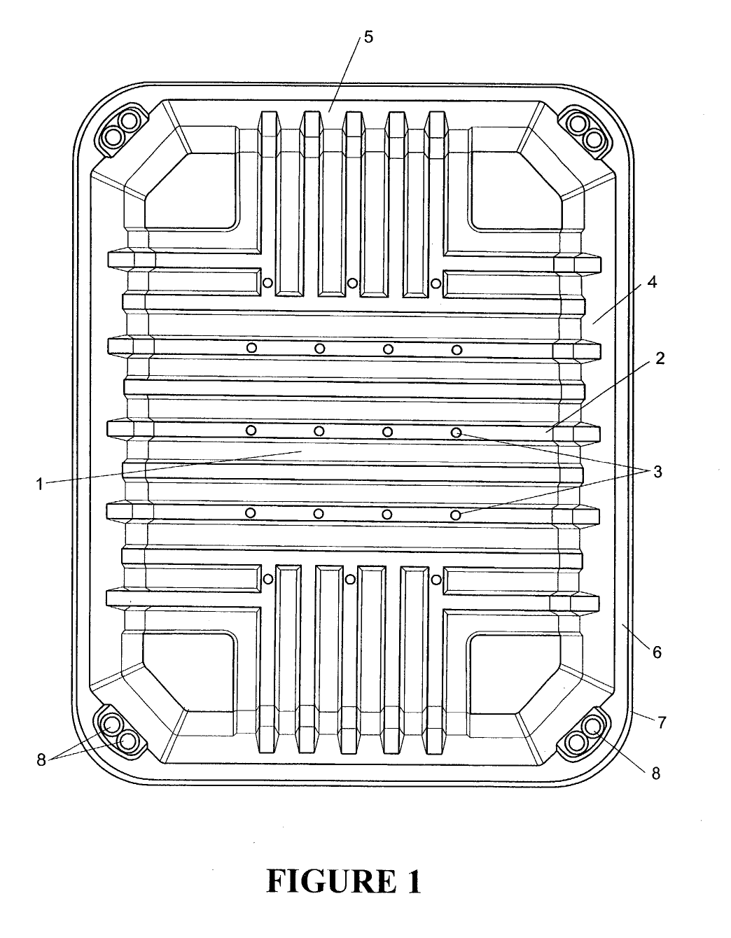

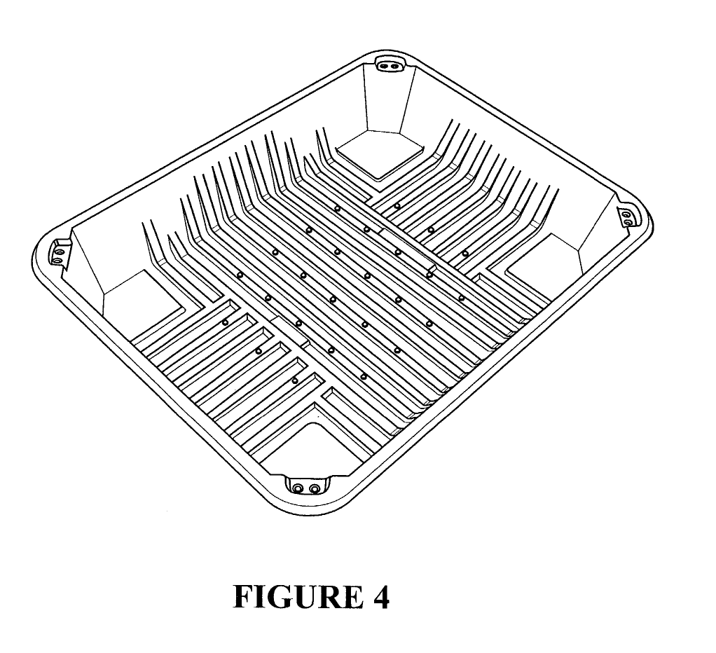

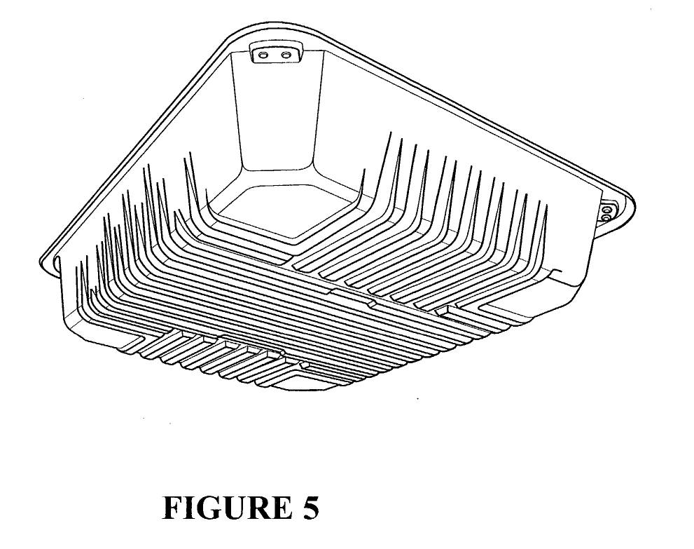

It can be seen in the tray embodiment of FIGS. 1, 4, 5 and 6 that the product retention zone 1 of the tray, inwardly of upstanding but outwardly flared side walls 4 and end walls 5, can be located within the wall boundaries, directly or indirectly on the spikes any product or products are to be displayed.

The corner regions (preferably curved) are formed with perforations or vents 8 which allows, even in a tear sheet enclosed tray of the present invention, the evacuation or flushing of air from within the otherwise closed pack. A more desirable gas environment (eg; nitrogen and/or carbon dioxide) can then contact the product. In this respect the almost sealed yet closed product can then, if desired, be wrapped with an oxygen impervious wrap to confine a flushing gas or could be bulk stored in an air impervious container or bag or one rich in the desirable gas. At a retail outlet, if desired, such vents can allow air to ingress into the container after removal from the air excluding surround whereupon red meat will bloom to a more aesthetic and desirable colour.

See for example, PCT/US96/16117 (WO 97/14313) as to how such a system (albeit without such recessed openings) can work and desirable materials to use.

The nature of the base with its ribs 2 and its depressions therebetween is such as to better allow air movement in and out of the enclosed tray whilst the upstanding ribs 2 allow for the even prouder presentation of preferably conical or other spiked form protuberances 3.

FIG. 1 also shows how a lip or surround flange 6 is provided on the raised perimeter of the tray leading over to a downturn 7 of the lip or flange 6. All of this adds to strength and less likelihood of cover film damage.

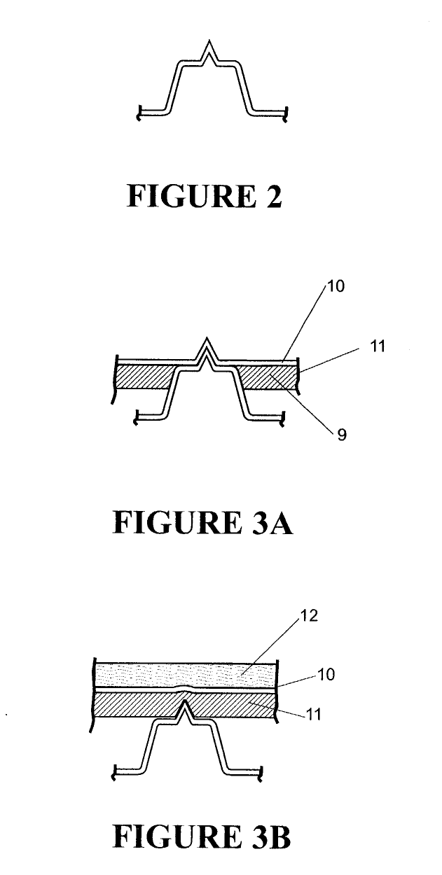

FIG. 2 shows the section across a rib 2 at a protuberance 3 showing how there is a blind recess when viewed from below leading to a solid point presentation.

FIG. 3A shows a soaker pad conforming to the spike, the soaker pad 9 shown in FIG. 3 having a liquid impervious upper layer 10 (eg; of polyethylene) and an absorbent matrix 11 attached thereto, for example, spun bond polyester or polyethylene enveloping SAP or other absorbent material.

FIG. 3B shows a spike simply locating a thick and/or less conforming or penetrable soaker pad on a spike with the location of the meat or other product being reliant on meat or product adherence to the soaker pad material.

Any other form of soaker pad can be utilised instead.

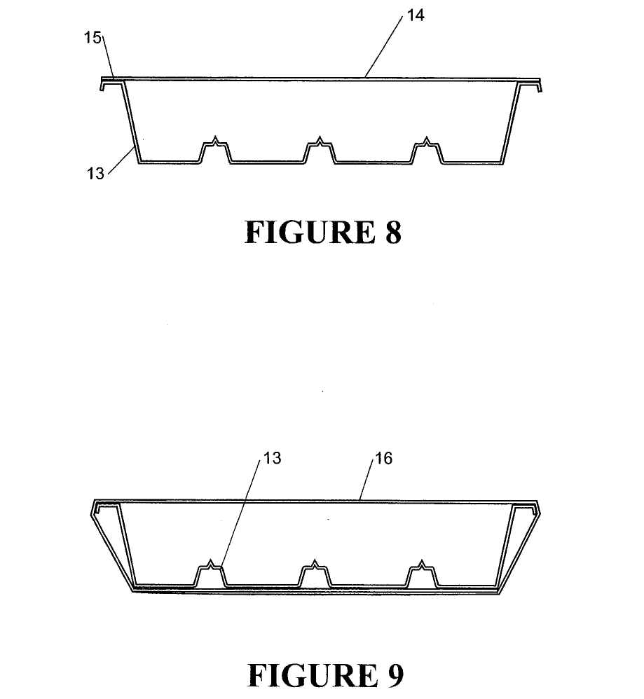

FIGS. 8 through 12 show certain closure options. For example, in FIG. 8, a tray 13 has a lidding film 14 welded or adhesively bonded at the region 15 completely around the tray.

There is an option with such a construction that no perforation or venting 8 be provided and instead the lidding film and tray be of an appropriate material that does not allow for gas exchange. For example, the tray could be made of a thermoplastic or combination of thermoplastic to make it substantially impervious to gas exchange similar to that of a barrier tray. Such a tray, with or without a soaker pad, could then be sealed by a lidding film 14 to the peripheral lip of the tray to prevent any substantial gas exchange if appropriately sealed fully to the peripheral lip, be without perforations and be of an appropriate barrier film. An example of such a largely gas exchange preventing film is a clear barrier lidding film (preferably with an anti-fog) of which examples are CRYOVAC™ lid 1050 or TOPLEX™ shrink 47.

Alternatively the tray does include vents or perforations 8 that allow for rapid gas exchange in which case the lidding film can be as aforesaid or alternatively can be highly permeable to gas. Such closed packs can be accumulated and maintained in gas flushed or evacuated master pack impervious to any substantial degree of air ingress (such as that offered as a system by Secure Fresh and disclosed in their patents). A retail outlet can completely empty the master pack and load the closed packs as they bloom into a display refrigerator.

FIG. 9 shows a stretch film wrapped tray. In this form the tray 13 has the film 16 provided by multiple layers of film heat sealed to one another under the tray. The film could be perforated to allow gas exchange and the tray perforations or vents 8 to ensure gas exchange between the two enclosed regions as in the aforementioned Transhumance patent. Alternatively the film can be perforated over both regions whereupon no vents or perforations 8 would need to be employed to enable gas interchange (eg; from air to controlled atmosphere and subsequently the reverse).

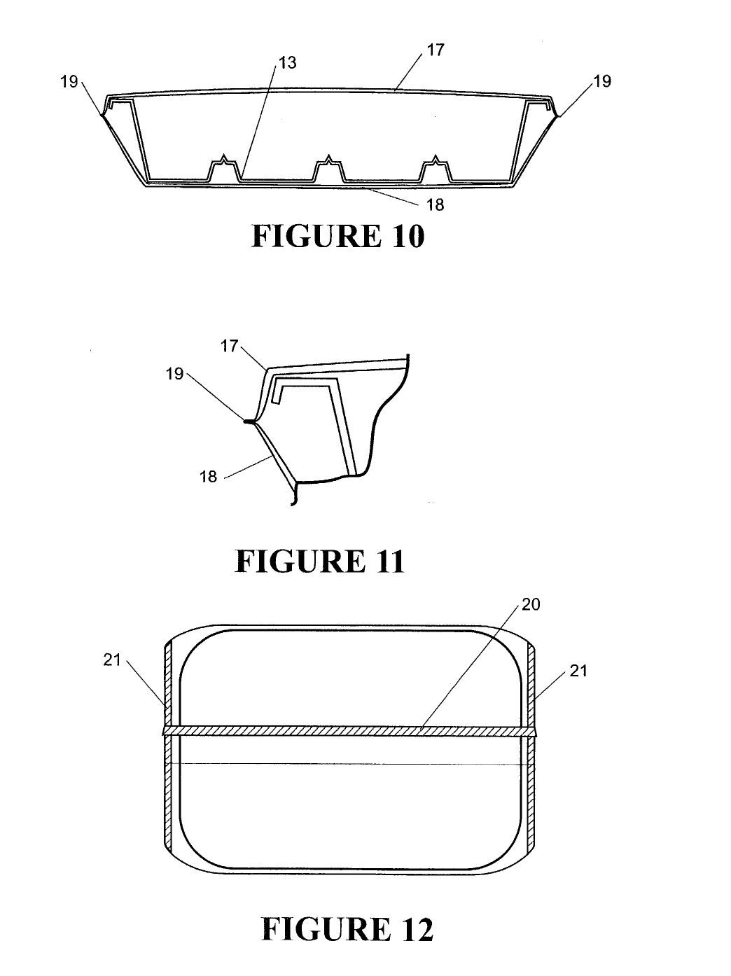

FIG. 10 shows yet another variant. In this embodiment the tray 13 in a similar way to the over wrapping of FIG. 9 is encompassed by a shrink film but in this case by two sheets of shrink film 17 and 18 which are welded one to the other at 19. Such welding would be fully about the tray.

With the arrangement as shown in FIG. 12 (a plan view looking up at the base) the same principles as over wrapping apply except that the stretch film is applied in a flow wrap method which results in a longitudinal seal 20 as well as end seals 21.

Any appropriate heat seal technology may be used for any such sealing and/or welding including any mentioned earlier.

The present invention allows different size product presentations in the product retention zone or indeed even a miscellany of products. The existence of the protuberances, which bear directly on the product and/or on the soaker pad (product adherent or not) has the effect of reducing movement of the product within the retention zone thus maintaining the aesthetic spread of product at the time of packing throughout the retail process irrespective of whether or not the tray is presented flat or inclined.

Where reference herein is made to a view from below the tray it is a reference to a view in a direction opposite to the direction of viewing of the product retention zone.

We claim:

1. A tray thermoformed from a sheet or web (hereafter “web”) of a thermoplastics film characterised in that it has at least one product retention zone (“the product retention zone”) inward of a raised perimeter, said retention zone of the tray presenting at least one upstanding protuberance.

2. A tray as claimed in claim 1 wherein said at least one upstanding protuberance is a plurality of spikes.

3. A tray as claimed in claim 2 wherein at least one (or some) of the spikes is (are) at least about as upstanding as it is (they are) wide at its (their) base.

4. A tray as claimed in claim 2 wherein each said spike(s) stands (stand) proud of the surrounding thermoplastic material which itself is raised (eg; as a rib, ridge or plateau) from at least much of the remainder of the retention zone defining thermoplastic material.

5. A tray as claimed in claim 1 wherein the or each said upstanding protuberance is formed so as, when viewed from below the tray, to provide a blind recess.

6. A tray as claimed in claim 5 wherein each said blind recess underlies a solid plastics point.

7. A tray as claimed in claim 1 wherein said protuberance is substantially conical.

8. A tray as claimed in claim 1 wherein said tray is substantially rectangular or square in plan albeit with optional corner truncation or rounding.

9. A tray as claimed in claim 1 wherein the or each protuberance stands proud from a rib, ridge or plateau.

10. A tray as claimed in claim 1 wherein said raised perimeter defines upstanding (but preferably outwardly splayed) walls.

11. A tray as claimed in claim 10 wherein said walls include a peripheral flange.

12. A tray as claimed in claim 11 wherein said flange is flat or convex (eg; curving from a curved or flat flange region or lip to define a distal downturn).

13. A tray as claimed in claim 1 wherein the ribs, ridges and/or plateau are adapted
(iii) to allow liquid pooling or accumulation (in the absence of a soaker pad) or exudate in use from any content place on said tray in said retention zone, and/or
(ii) to allow channelling of gas under the tray even when it is fully wrapped by a cling film.

14. A tray as claimed in claim 1 wherein said raised perimeter includes one or more opening through the plastics material.

15. A tray as claimed in claim 14 wherein said opening(s) is (are) in a set down region or set down regions of the raised perimeter (ie; of a peripheral flange thereof).

16. In combination, a tray as claimed in claim 1 and a soaker pad capable of being positioned on the tray over at least part of said retention zone yet to still present a capability, owing to the presence of such upstanding protuberances, of locating a meat, fish or the like product or products therein.

17. An assembly comprising or including
a tray of a thermoplastics material having at least one upstanding protuberance inwardly of the periphery thereof,
(optionally) a soaker pad or the equivalent located on the tray over said at least one upstanding protuberance,
at least one meat, fish or derivative products located on said tray (optionally at least in part over any optional soaker pad), and
a closure onto and/or at least in part about the tray over the meat, fish or derivative product(s) of a film or foil.

18. An assembly as claimed in claim 17 wherein said tray has been thermoformed from a sheet or web (hereafter “web”) of a thermoplastics material.

19. An assembly as claimed in claim 17 wherein said closure is with a plastics film.

20. An assembly as claimed in claim 17 wherein said closure is as a wrap.

21. An assembly as claimed in claim 17 wherein said closure is as a tear off sheet welded (eg; heat, RF, acoustically or the like) or otherwise affixed (eg; adhesive) to an upper region of a raised periphery of the tray.

22. An assembly as claimed in claim 17 wherein said soaker pad is interposed between the tray and the meat, fish or derivative product, and the upper surface of the soaker pad substantially conforms to and/or is penetrated by the protuberance(s).

23. An assembly as claimed in claim 17 wherein said tray is a tray as claimed in claim 1.

24. An assembly as claimed in claim 17 wherein a plurality of product covering sheets are provided.

25. An assembly as claimed in claim 17 wherein the closure over the product(s) is of a transparent material.

26. The use of a tray of a kind as claimed in claim 1.

27. A presentation of a meat, fish or derivative product(s) in a tray as claimed in claim 1 under an appropriate closure or in an assembly as claimed in claim 25.

28. A method of packaging meat, fish or derivative product(s) which involves the operative use of a tray as claimed in claim 1 or which results in an assembly as claimed in claim 17.
